(19) United States
(12) Patent Application Publication
(10) Pub. No.: US 2022/0339660 A1
(43) Pub. Date: Oct. 27, 2022

(54) GLUE VAPOR SUCTION DEVICE FOR A LABELER, HOT GLUE UNIT WITH THE GLUE VAPOR SUCTION DEVICE, AND HOT GLUE METHOD

(71) Applicant: Krones AG, Neutraubling (DE)

(72) Inventors: Konrad SENN, Altegofsheim (DE); Bernd SCHROLL, Kulmain (DE)

(21) Appl. No.: 17/659,158

(22) Filed: Apr. 13, 2022

(30) Foreign Application Priority Data
Apr. 23, 2021 (DE) 102021110400.9

(51) Int. Cl. B05C 11/10; C09J 5/00

(52) U.S. Cl. CPC B05C 11/1039; C09J 5/00

(57) ABSTRACT

The disclosure relates to a hot glue method for applying hot glue onto labels and/or containers using the hot glue unit, and to a glue vapor suction device for a labeler, comprising a suction opening, a suction, a pre-separation unit, a filter unit, and an outlet opening, which are arranged in communication with one another successively by lines in a direction of flow of the glue vapor through a fluid line system. At least one sensor system is arranged in the suction for verifying proper operation of the glue vapor suction. A hot glue unit is provided comprising at least one glue roller, a glue container, and a housing in which the glue roller is arranged. The hot glue unit comprises a glue vapor suction device connected to the housing for sucking glue vapor from the interior of the housing before it exits the hot glue unit.

### CROSS-REFERENCE TO RELATED APPLICATION

The present application claims priority to German Patent Application No. 102021110400.9 filed on Apr. 23, 2021. The entire contents of the above-listed application are hereby incorporated by reference for all purposes.

### TECHNICAL FIELD

The disclosure relates to a glue vapor suction device for a labeler, to a hot glue unit with a glue vapor suction device for a labeler, and to a hot glue method.

BACKGROUND AND SUMMARY

Hot glue units in which glue vapor is produced during operation are known from prior art in connection with labelers in the field of the beverage processing industry.

DE 20 2017 105 400 U1 and DE 10 2019 203 581 A1 each disclose a hot glue unit for a labeler in the beverage processing industry with at least one glue roller arranged in a housing and with a glue container. The hot glue unit comprises a filter unit connected to the housing having a suction that can suck gases from the interior of the housing and supply them to the filter unit before the gases can leave the hot glue unit. DE 10 2019 203 581 A1 further discloses that a cyclone unit is provided in the direction of flow of the gases downstream of the suction and is in communication with the suction by way of a droplet separator.

Previous devices for sucking glue vapor do not verify whether the motor of the cyclone unit is running and/or whether there are other faults present in the device. It is therefore not possible to verify whether the suction is operating properly. As a result, the temperature in the hot glue unit can change due to a failure or reduced performance of the suction, which has a direct impact on the labeling quality.

Proceeding from known prior art, the technical object to be solved is therefore to provide a glue vapor suction device for a labeler, a hot glue unit with such a glue vapor suction device and a hot glue method which enables the vapors that are produced when the hot glue is heated to be sucked reliably.

This object is solved by a glue vapor suction device for a labeler, a hot glue unit with a glue vapor suction device for a labeler, and a hot glue method.

The glue vapor suction device for a labeler comprises a suction opening, a suction, a pre-separation unit, a filter unit, and an outlet opening, which are in communication with one another by lines successively in a direction of flow of the glue vapor through a fluid line system. At least one sensor system is arranged in the suction for verifying proper operation of the glue vapor suction.

The pre-separation unit can be or comprise a vortex tube, a cyclone, an impact separator or the like. The vortex tube, the cyclone, the impact separator or the like can each also be provided in combination with a demister. The pre-separation unit can be or comprise an electrostatic separator.

The direction of flow in the glue vapor suction device can be caused by the pre-separation unit and/or also by one or more additional fans in the fluid line system.

The fluid line system can be and/or comprise a pipe and/or hose system.

The pre-separation unit can comprise a motor. The one or more additional fans in the fluid line system can comprise a motor each or a common motor.

A flow path can run through the glue vapor suction device, for example through the elements it comprises, such as the suction opening, the suction, the pre-separation unit, the filter unit, and the outlet opening, and the fluid line system. Glue vapor can be sucked along the flow path.

The pre-separation unit is a unit in which air turbulence is generated, for example, by way of one or more fans. The centrifugal force driving the drops to the outer wall of the pre-separation unit, where the droplets are separated, acts upon the droplets present in the glue vapor, while the remaining glue vapor can pass through the pre-separation unit. In order to further promote the separation, the outer wall of the cyclone unit, on which the separated droplets impinge, can be cooled in order to prevent renewed evaporation.

The glue vapor suction device can also comprise a collection container which is communication by lines with the fluid line system and/or the pre-separation device. The separated droplets, for example, from the pre-separation unit and a droplet separator, can be collected in the collection container.

Arranged in the fluid line system downstream of the pre-separation unit can be one or more additional fans by way of which a sufficient flow can be generated for conveying the glue vapor from the suction in the direction of flow to the pre-separation unit.

The filter unit is arranged in the direction of flow downstream of the pre-separation unit and can comprise a fine filter and additionally, for example, a paper filter with activated carbon arranged downstream of the fine filter. Particles remaining in the glue vapor can be filtered out by the filter unit after having passed through the pre-separation unit. The driving force for the filtration is a pressure difference of the glue vapor upstream and downstream of the filter unit. The glue vapor can either be sucked through the filter unit or forced through the filter by overpressure.

It can be provided that one or more further fans are arranged in the fluid line system downstream of the filter unit.

The at least one sensor system can be arranged at different positions in the suction. For example, a sensor, e.g. a temperature gauge, can be arranged at a position between the suction and the pre-separation unit and a further sensor, e.g. a differential pressure gauge, at a different position between the suction and the filter unit. By arranging the at least one sensor system in this manner, it is possible to verify at different positions in the suction whether the glue vapor suction device is operating properly, and it can be ensured that no unwanted glue vapor contamination arises.

Operating properly can mean, for example, improper piping of the fluid line system and/or an improperly installed collection device and/or a filter unit that is not enclosed. The flow path can be interrupted completely or in part and/or unwanted external air, for example, ambient air, can be drawn in.

Another or an additional improper operation can comprise clogging of the filter unit, for example, of one or more filters of the filter unit, of the pre-separation device, of a possible demister, or of another component with dirt and/or condensate so that proper suction can no longer be performed.

Another or an additional improper operation can be the incorrect flow rate, for example, caused by wear, incorrect adjustment, or a technical defect in the cable and/or at the motor of the pre-separation unit and/or the one or more fans in the fluid line system.

The at least one sensor system can comprise a differential pressure gauge that is configured to measure and output a value of a differential pressure.

During operation of the glue vapor suction device, the measured differential pressure in the suction can increase or decrease in dependence of the position of the at least one sensor system if the glue vapor suction does not operate properly. If a respective change in the differential pressure measured has been determined, further steps can be necessary in order to prevent undesired glue vapor contamination and/or damage to the glue vapor suction device.

The glue vapor suction device can also comprise a control device that can be configured to compare a given limit value of the differential pressure with the (measured) value of the differential pressure and to output a warning message if the given limit value is exceeded or falls short, where an acoustic and/or visual output of the warning message can be provided. The output of the warning message when the given limit value is exceeded or falls short can depend on the position of the at least one sensor system.

The given limit value of the differential pressure can be predefined or can be entered and/or set individually by an operator.

The control device can be further configured to cause a hot glue unit from which the glue vapor originates and/or the glue vapor suction device to be shut down when the differential pressure exceeds or falls short of the given limit value.

Alternatively or additionally, the sensor system can comprise a temperature gauge which can be configured to measure and output a value of a temperature.

If the glue vapor suction device is not operating properly, the temperature in the suction can increase.

The glue vapor suction device can also comprise a further control device which can be configured to compare a given limit value of the temperature with the (measured) value of the temperature and to output a warning message if the given limit value is exceeded, where, for example, an acoustic and/or visual output of the warning message can be provided.

The warning message can be output visually by way of a warning light and/or by way of a human-machine interface (HMI) and/or by way of a smart device (smartphone, smartwatch or the like).

The given limit value of the temperature can be predefined or can be entered and/or set individually by an operator.

The control device and the further control device can be comprised by a control unit; but they can also each be separate control units.

The further control device can be further configured to cause a hot glue unit from which the glue vapor originates and/or the glue vapor suction device to be shut down when the given limit value of the temperature is exceeded.

The sensor devices arranged in the suction can be arranged between the suction and the filter unit. This arrangement of the sensor devices can make it possible to detect a clogged filter unit and/or a non-operational fan, which can be arranged in the fluid line system, when the differential pressure decreases.

The glue vapor suction device can further comprise at least one droplet separator, where the at least one droplet separator can be configured, for example, to be coolable.

The glue vapor can be cooled in the at least one droplet separator so that the temperature drops, for example, below a condensation temperature of the glue components contained in the glue vapor. This can lead to improved droplet separation.

An outer wall of the pre-separation unit can be configured to be coolable in order to prevent separated droplets that impinge there from evaporating again.

It can be provided that the condition of the pre-separation unit is monitored directly. Suitable sensors, such as pressure sensors, can be connected to the pre-separation unit and measure the differential pressure upstream and downstream of the pre-separation unit. The measurement results can be displayed, for example, on a control unit (in particular a display of the control unit) or otherwise processed by use of a computer or a similar device for processing data. Other methods for measuring certain properties, such as inductive, optical or capacitive methods are possible there. The measured values obtained can be used to determine whether the pre-separation unit and in particular the outer wall of the pre-separation unit, on which droplets can separate, are already clogged or blocked by the condensate of droplets. Should this be detected, then an operator can be prompted to exchange or clean the pre-separation unit.

The hot glue unit comprises at least one glue roller and a glue container, as well as a housing in which the glue roller is arranged, where the hot glue unit comprises a glue vapor suction device for a labeler connected to the housing, as described above or below.

The housing can be substantially closed, where the suction of the glue vapor suction device, with which air can be sucked directly from the housing via the suction opening, is able to be connected to the former. For this purpose, suction is in direct communication with the interior of the housing, for example, via the suction opening. The housing and the suction may be configured such that no glue vapor can exit the housing except through suction. The housing together with the suction can therefore be considered to be a substantially closed system.

A hot glue method is provided for applying hot glue onto labels and/or containers using a hot glue unit, as described above or below, where the glue vapor suction device connected to the housing of the hot glue unit sucks the glue vapor from the interior of the housing before the glue vapor exits the hot glue unit and the proper operation of the glue vapor suction is verified by way of the at least one sensor system.

In the hot glue method, a pressure difference can be measured, for example, by way of the at least one sensor system. The measured value can be compared with the limit value pre-determined and—depending on the position of the at least one sensor system—a warning message can possibly be output and/or a hot glue unit from which the glue vapor originates and/or or the glue vapor suction device can be caused to shut down if the limit value specified is exceeded or falls short.

Alternatively or additionally, for example, a temperature can be measured in the hot glue method by way of the at least one sensor system. The value measured can be compared with the limit value pre-determined and a warning message can possibly be output and/or a hot glue unit from which the glue vapor originates and/or or the glue vapor suction device can be caused to be shut down if the limit value predetermined is exceeded.

### BRIEF DESCRIPTION OF THE FIGURES

FIG. 1 is intended for better understanding and for the illustration of aspects of the disclosure and shows a schematic view of a hot glue unit with a glue vapor suction device for a labeler.

### DETAILED DESCRIPTION

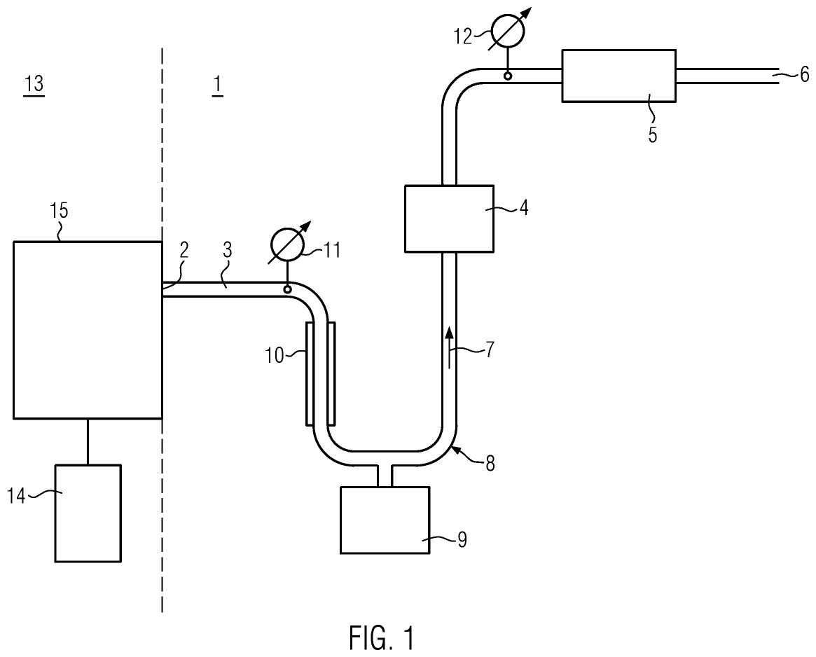

FIG. 1 shows a schematic view of a hot glue unit 13 with a glue vapor suction device 1 for a labeler. Hot glue unit 13 comprises a housing 15 in which at least one glue roller is arranged. In addition, hot glue unit 13 comprises a glue container 14 which is in communication with housing 15 for being able to supply the at least one glue roller with glue.

Housing 15 can be regarded to be substantially enclosed. In addition to the connection to glue container 14, the housing can have a connection opening or the like to which suction opening 2 of glue vapor suction device 1 can be connected for glue vapor suction.

Glue vapor suction device 1 comprises suction opening 2 and an adjoining suction 3. For example, housing 15 and suction 3 are configured such that no glue vapor can exit housing 15 except via suction 3. Housing 15 together with glue vapor suction device 1 can therefore be considered to be a substantially closed system.

A droplet separator 10 can be arranged when viewed in a direction of flow 7 of the glue vapor downstream of suction 3. Droplets of glue can be separated from the glue vapor in droplet separator 10. Droplet separator 10 can be configured to be coolable so that, for example, a temperature can be generated that is lower than a condensation temperature of the glue components contained in the glue vapor.

One or more fans (not shown) can be arranged downstream and/or upstream of droplet separator 10 for generating a flow for transporting the glue vapor from suction 3 in direction of flow 7 to and through droplet separator 10.

Arranged downstream of droplet separator 10 is a collection container 9 in which the droplets separated in droplet separator 10 as well as in a pre-separation unit 4 arranged downstream of droplet separator 10 can be collected.

Pre-separation unit 4 can generate air turbulence in the form of a “cyclone”, for example, by way of one or more fans. As a result, the droplets that are still contained in the glue vapor after exiting droplet separator 10 can be separated from the remaining glue vapor for the reason that a centrifugal force acts upon them which drives them to the outer wall of pre-separation unit 4. Pre-separation unit 4 can comprise, for example, small pores or other openings at suitable points in pre-separation unit 4 through which liquid from the separated droplets can reach collection container 9.

A filter unit 5 is arranged downstream of pre-separation unit 4 and upstream of an outlet opening 6. Viewed in direction of flow 7, filter unit 5 can comprise one or more filters, for example, a fine filter and a paper filter with activated carbon, arranged downstream of the fine filter.

While the liquid residue of the glue vapor can be sucked in the form of separated droplets by droplet separator 10 and pre-separation unit 4, the filter unit can also filter small particles.

Arranged upstream of pre-separation unit 4 and/or optionally of filter unit 5 can be one or more fans (not shown), the direction of rotation of which is oriented such that the glue vapor is sucked from housing 15 through suction opening 2, and can be supplied to droplet separator 10, to pre-separation unit 4, and to filter unit 5.

The glue vapor exiting glue vapor suction device 1 through outlet opening 6 can have breathing air quality, for example, also clean room quality.

The elements of glue vapor suction device 1 are in communication with one another by lines via a fluid line system 8. The one or more fans for generating a flow in direction of flow 7 can be arranged in fluid line system 8.

A first sensor system 11 and a second sensor system 12 are comprised by glue vapor suction device 1 in FIG. 1 by way of example for verifying proper operation of the glue vapor suction.

First sensor system 11 can comprise a temperature gauge which can be configured to measure and output a value of a temperature, for example, of the glue vapor in the region of the temperature gauge. The temperature can rise, for example, if the glue vapor is not sucked sufficiently or not at all.

A control device can compare a given limit value of the temperature with the measured value of the temperature and output a warning message if the given limit value is exceeded. The warning message can be output acoustically and/or visually.

The control device can be further configured to cause a hot glue unit from which the glue vapor originates and/or the glue vapor suction device to be shut down when the given limit value of the temperature is exceeded.

Second sensor system 12 can comprise a differential pressure gauge that is configured to measure and output a value of a differential pressure. During the operation of glue vapor suction device 1, a reduction in the differential pressure measured can arise if filter unit 5 gradually clogs and/or if one or more fans in the fluid line system are not operating properly.

A given limit value of the differential pressure can be compared with the measured value of the differential pressure by way of a further control device of glue vapor suction device 1 and a warning message can be output if the value falls short of the given limit value. The warning message can be output acoustically and/or visually.

The control device can be additionally configured to cause a hot glue unit from which the glue vapor originates and/or the glue vapor suction device to be shut down when the differential pressure falls short of the given limit value.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A glue vapor suction device for a labeler comprising a suction opening, a suction, a pre-separation unit, a filter unit, and an outlet opening, which are arranged in communication with one another by lines successively in a direction of flow of glue vapor through a fluid line system,
wherein
at least one sensor system is arranged in the suction for verifying proper operation of glue vapor suction.

2. The glue vapor suction device according to claim 1, wherein the at least one sensor system is configured to be arranged at different positions in the suction.

3. The glue vapor suction device according to claim 1, wherein the at least one sensor system comprises a differential pressure gauge that is configured to measure and output a value of a differential pressure.

4. The glue vapor suction device according to claim 3, further comprising a control device that is configured to compare a given limit value of the differential pressure with the value of the differential pressure and to output a warning message if the given limit value is exceeded or falls short.

5. The glue vapor suction device according to claim 4, wherein the control device is furthermore configured to cause a hot glue unit from which the glue vapor originates and/or the glue vapor suction device to be shut down when the differential pressure exceeds the given limit value.

6. The glue vapor suction device according to claim 1, wherein the at least one sensor system comprises a temperature gauge that is configured to measure and output a value of a temperature.

7. The glue vapor suction device according to claim 6, further comprising a further control device which is configured to compare a given limit value of the temperature with the value of the temperature and to output a warning message if the given limit value is exceeded.

8. The glue vapor suction device according to claim 7, wherein the further control device is further configured to cause a hot glue unit from which the glue vapor originates and/or the glue vapor suction device to be shut down when the temperature exceeds the given limit value.

9. The glue vapor suction device according to claim 1, wherein the at least one sensor system arranged in the suction is arranged between the suction and the filter unit.

10. The glue vapor suction device according to claim 1, further comprising at least one droplet separator.

11. The glue vapor suction device according to claim 1, wherein an outer wall of the pre-separation unit is configured to be coolable.

12. A hot glue unit comprising at least one glue roller and a glue container, as well as a housing in which the glue roller is arranged, wherein the hot glue unit comprises the glue vapor suction device according to claim 1 connected to the housing.

13. A hot glue method for applying hot glue onto labels and/or containers using the hot glue unit according to claim 12, wherein the glue vapor suction device connected to the housing of the hot glue unit sucks the glue vapor from an interior of the housing before the glue vapor exits the hot glue unit and where the proper operation of the glue vapor suction is verified by way of the at least one sensor system.

14. The glue vapor suction device according to claim 4, wherein the control device is configured to provide an acoustic and/or visual output of the warning message.

15. The glue vapor suction device according to claim 7, wherein the further control device is configured to provide an acoustic and/or visual output of the warning message.

16. The glue vapor suction device according to claim 10, wherein the at least one droplet separator is configured to be coolable.
